(19) United States
(12) Patent Application Publication
(10) Pub. No.: US 2022/0095599 A1
(43) Pub. Date: Mar. 31, 2022

(54) EASY-TIE FISHING HOOK

(71) Applicants: Thomas LIN, Independence, MO (US); Chun Shiong LIN, Independence, MO (US); Jefferson LIN, Independence, MO (US); Philip LIN, Independence, MO (US); Ziu Eng XU, Independence, MO (US)

(72) Inventors: Thomas LIN, Independence, MO (US); Chun Shiong LIN, Independence, MO (US); Jefferson LIN, Independence, MO (US); Philip LIN, Independence, MO (US); Ziu Eng XU, Independence, MO (US)

(21) Appl. No.: 17/032,949

(22) Filed: Sep. 25, 2020

(51) Int. Cl. A01K 91/04; A01K 83/04; A01K 85/14; A01K 85/10; A01K 95/02

(52) U.S. Cl. CPC A01K 91/04; A01K 83/04; A01K 95/02; A01K 85/10; A01K 85/14

(57) ABSTRACT

A fishing hook has a shank, hairpin loop portion formed at an end of the shank, and a fastener at an opposite end of the shank. The hairpin loop portion extends downwardly from the end of the shank. The hairpin loop portion is flattened and has a width less than a diameter of the shank. The hairpin loop portion has an end extending away from the shank. The shank and the hairpin loop portion define a line-receiving slot therebetween. The fastener selected from the group consisting of a hook, a ring clip, a lobster clasp, another hairpin loop portion, and a weight.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

### 1. Field of the Invention

The present invention relates to generally to fishing hooks. More particularly, the present invention relates to fishing hooks in which the fishing line can be easily attached to the fishing hook. The present invention also relates to fishing hooks that are adaptable to allow a variety of other fishing accessories to be attached thereto.

### 2. Description of Related Art Including Information Disclosed Under 37 CFR 1.97 and 37 CFR 1.98

Tying fishing lines to fish hooks presents many problems. The use of such lines makes knot tying difficult even under good conditions. With wet and/or cold hands, this problem is greatly magnified. Because of the popularity of fishing, much interest has been directed toward finding ways of simplifying the attachment of fishing lines to fishing hooks.

In the past, various patents have issued with respect to the easy-tying fishing hooks. For example, U.S. Pat. No. 4,621,449, issued on Nov. 11, 1986 to K. Nakagawa, shows a fishing hook provided with a mushroom-like stopper portion which is formed at the top end part of the stem of the main body for tying the fishing line. There is also a notch formed on the axis of the stem toward the upper end part of the stem reaching the top of the tying portion.

U.S. Pat. No. 5,279,067, issued on Jan. 18, 1994 to B. O. Tollison, shows an easy-tie fishhook and a method of attaching a line to a hooked item, such as a fishing hook, a plug, a gig, a lure or a spoon. Each hooked item includes an elongated shank and an open-ended slot disposed contiguous with one end of the shank. The slot is tapered and formed when the material from which the shank is fabricated is bent back onto itself. The slot has a slight divergence toward the top end of the slot. A line having a transverse cross-section with a radius approximately equal to the radius of curvature of the closed-end of the slot is employed. In order to attach the line to the hooked item, one must place an end of the line through the slot, run a portion of the line past the slot along the shank, wrap the line extending beyond this portion around it and the shank, and finally pulling the free end of the line into the slot and toward the closed end thereof of the slot. When the line is so pulled, it entwines upon itself, bunches and wedges into the slot.

U.S. Pat. No. 5,647,616, issued on Jul. 15, 1997 to H. W. Hamilton, discloses a fish hook dispenser and tying device. A hand-held implement of two pieces serves to tie, secure and dispense fish hooks. The implement includes a cylindrical longitudinal bore, a vertical safety chamber, and an extended sliding mandrel tying end. A top plane provides a vertical opening for the safety hook chamber, the threading line guide, and the vertical flute guide. The second part includes a cylindrical longitudinal helical mandrel, a vertical receiving hook flute, a spring chamber, and a sliding mandrel tying end. The helical spring provides actuating and biasing means that urges the barbed fish hook into the vertical safety hook chamber exposing a secure hook eyelet for tying. The sliding mandrel tying end extends beyond the implement end portion. The sliding helical mandrel extends the vertical receiving hook flutes to dispense the hook.

U.S. Pat. No. 7,261,327, issued on Aug. 28, 2007 to H. Johnston, teaches a fish hook tying apparatus. This fish hook tying apparatus includes a housing with a shaft mounted therein for rotation about a longitudinal axis. An end of the shaft protrudes from one end of the housing to form a chuck including resilient jaws and a longitudinally movable collar. The chuck is formed to grasp the shank of the fishing hook in a closed-jaw position and to release the fishing hook in an open-jaw position. A lanyard with a free end attached to the shaft has a wound-position and an unwound-position. A spring is attached to the shaft and to the housing so as to produce a winding bias on the shaft when the lanyard is moved from the wound-position to the un-wound position. The winding bias tends to rotate the shaft from the unwound position of the lanyard to the wound position of the lanyard.

U.S. Pat. No. 9,185,894, issued on Nov. 17, 2015 to Abdulrahman et al., provides an automatic fish hook tying device that includes a hollow housing with an elongated slot formed therein. A fish hook holding assembly near one end of the slot adjustably holds a fish hook therein with an eye of the fish hook extending into the housing. A fishing line feeding assembly near the opposite end of the slot positively feeds a fishing line through a fishing line guide assembly, threading the line through the eye. A winding and spooling assembly winds the line around a detachable spool and forms coils around a standing line to initiate formation of a knot. A manipulator assembly carries the spool to form loops and thread the line through the loops during the knot-tying process. Upon completion of the knot, the tied fishing hook can be removed from the housing through the slot.

U.S. Pat. No. 3,402,957, issued on Sep. 24, 1968 to N. C. Peterson, describes a fish hook threading and tying device. A mandrel is provided with a funnel-shaped socket for receiving the eye of a fish hook and guiding a line through the eye before the line is wound around the mandrel. The mandrel has a groove that one side thereof through which an end portion of the line may be passed to form a knot when the wound line is slipped off the mandrel. The socket is slit and resiliently yieldable to frictionally hold the fish hook in place.

An important development in the field of easy-tie fish hooks is that of U.S. Pat. No. 5,689,911, issued on Nov. 25, 1997 to Lin et al. This patent describes a fishing hook having a shank portion with a hook at one end and a slotted portion formed at an end of the shank portion opposite the hook. The slotted portion has an area in surface-to-surface contact with a surface of the shank portion. The area in surface-to-surface contact with the surface of the shank portion is distal the end which is joined with the shank portion. The slotted portion includes a first end contiguously joined to the shank portion, a central portion extending from the first end and tapering inwardly toward the shank portion, and a second end extending outwardly from the shank portion at the area in surface-to-surface contact with the shank portion.

U.S. Pat. No. 10,694,726, issued on Jun. 30, 2020 to the present inventors, describes another easy-tie fishing hook. This fishing hook has a shank portion with a hook at one end a hairpin loop portion formed at an opposite end of the shank portion. The hairpin loop portion extends downwardly from the opposite end of the shank portion. The hairpin loop portion has a width or diameter that is less than a width or diameter of the shank portion. The hairpin loop portion has an end extending at an angle away from the shank. The hairpin loop portion has a longitudinal axis coplanar the longitudinal axis of the shank portion. The shank portion and the hairpin loop portion define a line-receiving slot.

FIG. 1 shows this prior art easy-tie fish hook of U.S. Pat. No. 5,689,911. The easy-tie fishing hook 10 includes a shank portion 12 having a hook 14 at one end and a slotted portion 16 formed at an end of the shank portion 12 opposite the hook 14. The slotted portion 16 has an area 18 in surface-to-surface contact with a surface of the shank portion 12. A line-receiving opening 20 is formed in the area between the slotted portion 16 and the surface of the shank portion 12.

In FIG. 1, it can be seen that the slotted portion 16 includes a first end 22 which is contiguously joined to an upper end of the shank portion 12. A central portion extends from the first end 22 and tapers inwardly toward the shank portion 12. The area 18 is in surface-to-surface contact with the surface of the shank portion opposite the first end. The line-receiving opening 20 is defined by the area between the shank portion 12, the first end 22 and the central portion 16. A second end 24 extends outwardly from the shank portion 12 from the end of the central portion 16 that is in surface-to-surface contact with the shank portion 12. The second end 24 serves as a guide for allowing a fishing line to enter through the area 18 and into the line-receiving opening 20. The area between the first end 22 and the second end 24 needs to be flattened in order to increase its elasticity.

In normal use, a fishing line can be secured within the line-receiving opening 20 by extending a portion of the line along a surface of the shank portion 12, wrapping the line around the shank portion 12, and pulling the wrapped-around line upwardly into the line-receiving opening 20 through the area 18 in surface-to-surface contact. Since the area 18 is in surface-to-surface contact with the surface of the shank portion 12, it is difficult, if not impossible, for the fishing line (secured in the fishing line receiving opening 20) to slide downwardly and outwardly therethrough. The second end 18 serves as a guide to facilitate the insertion of the wrapped-around fishing line into the line-receiving opening 20.

One of the problems with this prior art easy-tie fishing hook is that it was extremely difficult to manufacture. Additionally, the slotted portion was too inflexible for line tying. The slotted portion 16 had no structure which allowed for the retention of live bait between the hook 14 and the slotted portion 16. Additionally, and furthermore, it was found that the widened and flattened slotted portion 16 was oddly unattractive to fish. In other words, it was easier for fish to recognize the irregularity in the surface of the fishing hook 10. This is particularly true since the slotted portion 16 is significantly wider than the shank of the fishing hook 10. As such, a need has developed so as to create an easy-tie fishing hook that is easier to manufacture, more flexible for line tying, and more attractive to fish.

Referring to FIG. 2, there is shown the easy-tie fishing hook 30 in accordance with the teachings of U.S. Pat. No. 10,694,726 of the present inventor. The easy-tie fishing hook 30 has a shank portion 32 having a hook at one end thereof. The hook of the shank portion 32 will be identical to that of the hook 14 shown in FIG. 1. Similarly, the curvature of the shank portion 32 at the lower end thereof adjacent to the hook will be identical to the configuration shown in FIG. 1. Importantly, the improvement shown in U.S. Pat. No. 10,694,726 is the configuration of the hairpin loop portion 34 that is formed at an opposite end of the shank portion 32. The hairpin loop portion 34 is illustrated as extending downwardly from the opposite end 36 of the shank portion 32. It can be seen that the hairpin loop portion 34 has a width or a diameter that is less than a width or a diameter of the shank portion 32. The hairpin loop portion 34 has an end 38 that extends at an angle away from the shank portion 32.

In FIG. 2, it can be seen that the hairpin loop portion 34 has a longitudinal axis that is co-planar with the longitudinal axis of the shank portion 32. Since the hairpin loop portion 34 has a width or diameter that is less than a width or diameter of the shank portion 32, the hairpin loop portion has no surfaces that extend outwardly beyond the sides of the shank portion 32. As such, this hairpin loop portion 34 is concealed from viewing by a fish. Unlike the prior art shown in FI G. 1, the hairpin loop portion 34 is not spread out and does not present sharp edges or structures that can be more easily visible by the fish.

During the manufacturing process, the hairpin loop portion 34 can be suitably flattened prior to bending. After the hairpin loop portion 34 is flattened, it can be bent over in a conventional manner so as to reside in close proximity to the shank portion 32. As such, a line-receiving slot would be defined between the hairpin loop portion 34 and the shank portion 32.

FIG. 3 is a side view of the easy-tie fishing hook of U.S. Pat. No. 10,694,726. In FIG. 3, it can be seen that the hairpin loop portion 34 extends outwardly in relation to the shank portion 32. In particular, the hairpin loop portion 34 extends downwardly from an upper end 36 of the shank portion 32. The hairpin loop portion 34 will gradually move inwardly so as to be in close proximity to a surface of the shank portion 32. As such, a line-receiving slot 40 is defined between the shank portion 32 and the hairpin loop portion 34. The end 38 of the hairpin loop portion 34 extends downwardly at an obtuse angle from the remainder of the hairpin loop portion 34. As such, a funnel-type opening will lead into the line-receiving slot 40. This funnel-type opening 42 facilitates the ability to introduce the fishing line into the line-receiving slot 40. The bending of the end 38 can occur during the manufacturing process when the hairpin loop portion 34 is flattened. The tying of the fishing line onto the fishing hook 10 will be similar to that described in association with FIG. 1 hereinbefore.

It is an object of the present invention to provide an easy-tie fishing hook that is easy to manufacture.

It is another object of the present invention to provide an easy-tie fishing hook that has sufficient flexibility so as to facilitate line tying.

It is still another object of the present invention to provide an easy-tie fishing hook that is better able to retain live bait thereon.

It is still a further object of the present invention to provide an easy-tie fishing hook that is more attractive to fish and enhances the results of fishing.

It is still another object of the present invention to provide an easy-tie fishing hook that is relatively inexpensive and is easy to use.

It is still a further object of the present invention to provide an easy-tie fishing hook that is adaptable to support a wide variety of other items thereon, such as hooks, lures, clasps, clips and weights.

These and other objects and advantages of the present invention will become apparent from a reading of the attached specification and appended claims.

### BRIEF SUMMARY OF THE INVENTION

The present invention is a fishing hook that comprises a shank, a hairpin loop portion formed at an end of the shank, and a fastener formed at an opposite end of the shank. The hairpin loop portion extends downwardly from the end of the shank. The hairpin loop portion is flattened and has a width less than a diameter of the shank. The hairpin loop portion has an end extending away from the shank. The shank and the hairpin loop portion define a line-receiving slot therebetween. The end of the hairpin loop portion defines a funnel area toward the line-receiving slot. The fastener is selected from the group consisting of a hook, a ring clip, a lobster clasp, another hairpin loop portion, and a weight.

The hairpin loop portion continuously narrows from the opposite end of the shank toward the end of the hairpin loop portion. The hairpin loop portion continuously narrows in diameter or width from the opposite end of the shank. The hairpin loop portion has a longitudinal axis coplanar with the longitudinal axis of the shank. The end of the hairpin loop portion extends downwardly at an obtuse angle from a remainder of the hairpin loop portion.

In one embodiment of the present invention, the fastener is a treble hook. The treble hook has barbs. At least one of the barbs extends outwardly of the shank on the same side of the shank as the hairpin loop portion.

In another embodiment of the present invention, the fastener is a ring clip. The ring clip has a ring affixed at an end of the shank. The ring has a split in the circumference thereof. This split opens to the interior of the ring. The ring has a guide member extending outwardly therefrom at one side of the split. The guide member angles upwardly and outwardly away from the shank. The guide member is adapted to funnel toward the interior of the ring.

In another embodiment the present invention, the fastener is a lobster clasp defining a ring at the opposite end of the shank. The lobster clasp has an arm extending into an interior of the ring. The arm is adapted to open and close the ring. The ring clip can be of an elongated shape and the lobster clasp can also be of an elongated shape.

In another embodiment of the present invention, the fastener is another hairpin loop portion. This another hairpin loop portion extends upwardly from the opposite end of the shank. This another hairpin loop portion is flattened and has a width less than a diameter of the shank. This another hairpin loop portion has an end extending away from the shank. The shank and the another hairpin loop portion define a line-receiving slot therebetween. The end of the another hairpin loop portion defines a funnel area toward the line-receiving slot. A lure is affixed to the shank in a location between the hairpin loop portions. This lure can be selected from the group consisting of a spinnerbait, a scoop, a reflective surface, a spoon and a plug.

In still another embodiment of the present invention, the fastener is a weight. The weight has a circular configuration. The weight can have another shank extending upwardly therefrom. The weight has another hairpin loop portion extending downwardly from an end of the another shank opposite the weight. The another hairpin loop portion is adapted to engage with the fastener. The weight could also have a lobster clasp at the end of the shank opposite the weight. Alternatively, the weight can have a ring clip at the end of the shank opposite the weight. The lobster clasp or the ring clip is adapted to be received by the fastener of the fishing hook the present invention.

In still a further embodiment of the present invention, the fastener is a lure. In particular, the lure is a conventional fishing lure. The lure has at least one clasp extending outwardly from a periphery of the lure. In particular, in the preferred embodiment, there are a plurality of clasps. One of the clasps extends out of the forward portion of the lure. Another clasp extends outwardly of a rearward portion of the lure. Still another clasp will extend outwardly centrally of the body. These multiple clasps facilitate the ability for the fisherman to secure the lure in a variety of orientations in relation to the fishing hook.

This foregoing Section is intended to describe, with particularity, the various embodiments of the present invention. It is understood that modifications to these embodiments can be made within the scope of the present claims. As such, this Section should not to be construed, in any way, as limiting of the broad scope of the present invention. The present invention should only be limited by the following claims and their legal equivalents.

### BRIEF DESCRIPTION OF THE SEVERAL VIEWS OF THE DRAWINGS

FIG. 1 side elevational view of a prior art fishing hook.

FIG. 2 is a frontal view showing the hairpin loop portion and shank of the fishing hook of the prior art.

FIG. 3 is a side elevational view of the shank and hairpin loop portion of the prior art fishing hook.

FIG. 4 is a perspective view showing an embodiment of the fishing hook of the present invention with a treble hook.

FIG. 5A is a side elevational view of another embodiment of the fishing hook of the present invention with a ring clip.

FIG. 5B is a side elevational view of the fishing hook of the present invention having a lobster clasp.

FIGS. 6A and 6B are side elevational view showing the fastener as being, respectively, an elongated ring clip and an elongated lobster clasp.

FIG. 7 is a side elevational view of the fishing hook of the present invention as having a lure thereon.

FIGS. 8A-C show alternative embodiments of a weight as used in the fishing hook of the present invention.

FIG. 9 shows another alternative embodiment of the fishing hook of the present invention showing, in particular, a single hook.

FIG. 10 a side elevational view of still further embodiment of the fishing hook of the present invention and, in particular, showing a lure that can be secured to the fishing hook.

### DETAILED DESCRIPTION OF THE INVENTION

FIG. 4 shows the fishing hook 50 in accordance with a first embodiment of the present invention. The fishing hook 50 has a shank 52 having a hairpin loop portion 54 extending downwardly from an upper end 56 of the shank 52. A treble hook 58 is affixed to the lower end of the shank 52. Treble hook 58 has barbs 60, 62 and 64 extending outwardly therefrom. Barb 64 will be on the same side of the shank 52 as the hairpin loop portion 54. Since the barb 64 is on the same side of the shank 52 as the hairpin loop portion 54, it facilitates the ability to secure bait on the fishing hook 50. It can be seen that the end 66 of the hairpin loop portion 54 extends at an obtuse angle with respect to the remaining portion of the hairpin loop portion 54. This type of angling of the end 56 facilitates the ability to secure bait to the treble hook 58. In other words, if bait is used, a portion of the bait can be secured to the barb 64 and to the end 66. The bait can be live bait, lures, plastic worms, or other synthetic bait.

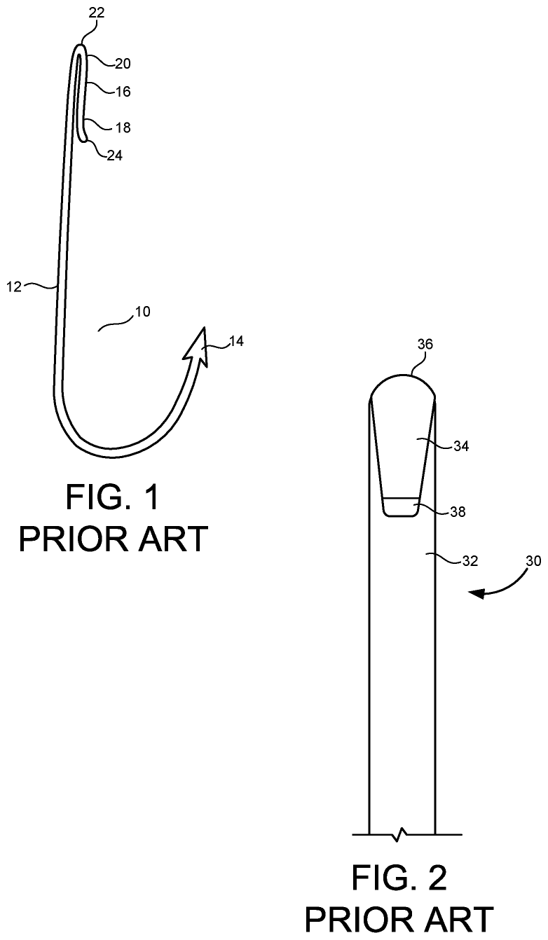

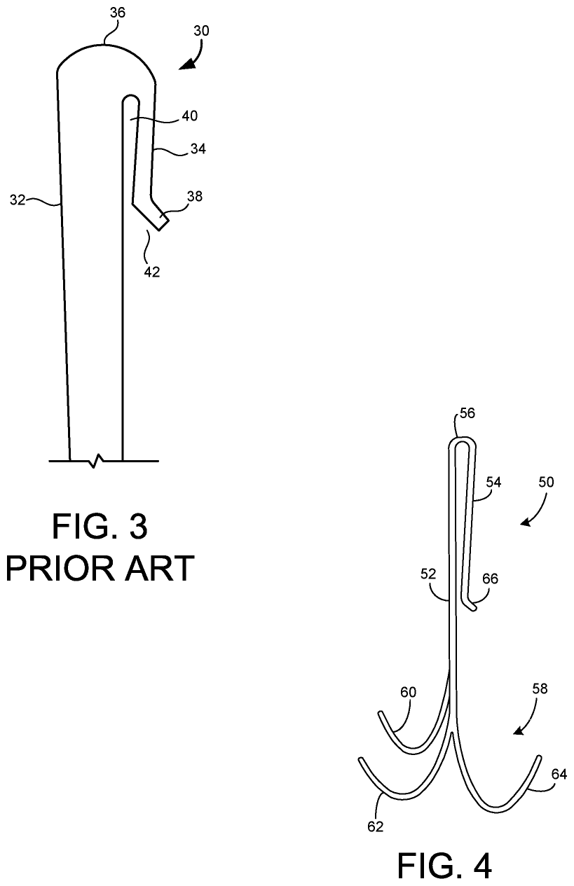

The treble hook 58 has barbs 60, 62 and 64 extending at evenly radially spaced positions. The hairpin loop portion 54 will have a configuration similar to that described in FIGS. 1-3 hereinbefore. As used herein, the treble hook 58 will be considered a “fastener” in accordance with the teachings of the present invention.

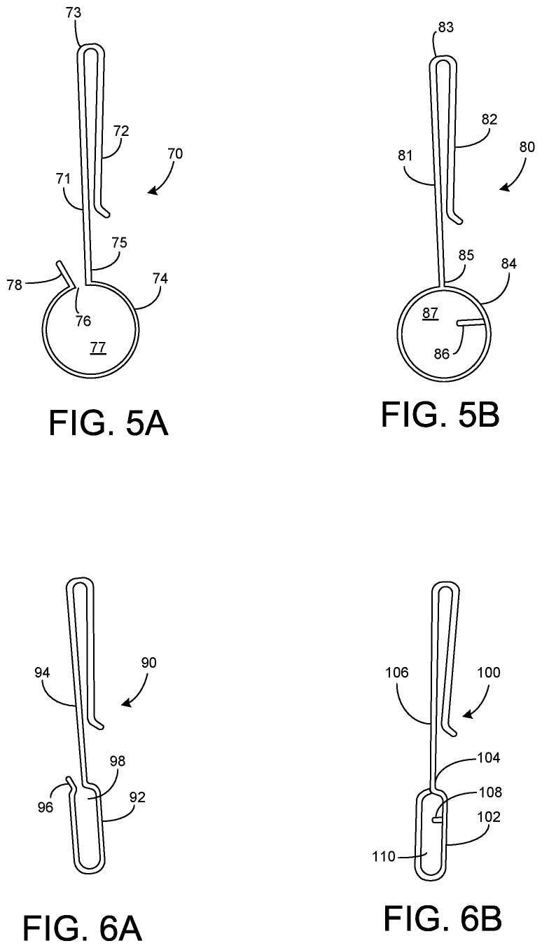

In many circumstances, it is desired to use the fishing hook so as to secure other items thereto, such as weights, lures, other hooks, and bait thereto. As such, FIGS. 5A and 5B show alternative embodiments 70 and 80 of the present invention. In FIG. 5A, fishing hook 70 has a shank 71 with a hairpin loop portion 72 extending downwardly from an upper end 73 of the shank 71. A ring clip 74 is formed at the lower end 75 of shank 71. Ring 74 has a split 76 formed therein. Split 76 forms an opening to the interior 77 of the ring clip 74. A guide member 78 extends upwardly and outwardly from one end of the split 76. As such, guide member 78 will serve as a funnel toward the interior 77 through the split 76. The guide member 78 will be on a side of the shank 71 opposite the hairpin loop portion 72.

FIG. 5B shows the fishing hook 80 as having a shank 81 and a hairpin loop portion 82 extending downwardly from the upper end 83 of the shank 81. A lobster clasp 84 is formed at the end 85 of the shank 81. Lobster clasp 84 will have an arm 86 extending into the interior 87 of the lobster clasp 84. The arm 86 is used to slidably open and close an opening formed in the circumference of the lobster clasp 84. As such, a lure, another hook, or other items can be received within the interior 84 by simply applying a force to the arm 86 so as to open the lobster clasp 84. After the item is installed, the arm 86 can be released so as to close the lobster clasp 84.

FIGS. 6A and 6B show an alternative embodiments of the fishing hooks 70 and 80 shown in FIGS. 5A and 5B. In particular, FIG. 6A shows fishing hook 90 similar to the teachings shown in FIG. 5A. However, FIG. 6A has an elongated ring clip 92 at the end of shank 94. The elongated ring clip 82 is in the nature of an elongated oval. The guide member 96 extends upwardly and outwardly so as to provide a funnel into the interior 98 of the elongated ring clip 92.

FIG. 6B shows a the fishing hook 100 as a variation of that shown in FIG. 5B. In particular, FIG. 6B shows an elongated lobster clasp 102 formed at an end 104 of shank 106. The lobster clasp 102 will have an elongated oval configuration. Arm 108 extends into the interior 110 of the lobster clasp 102.

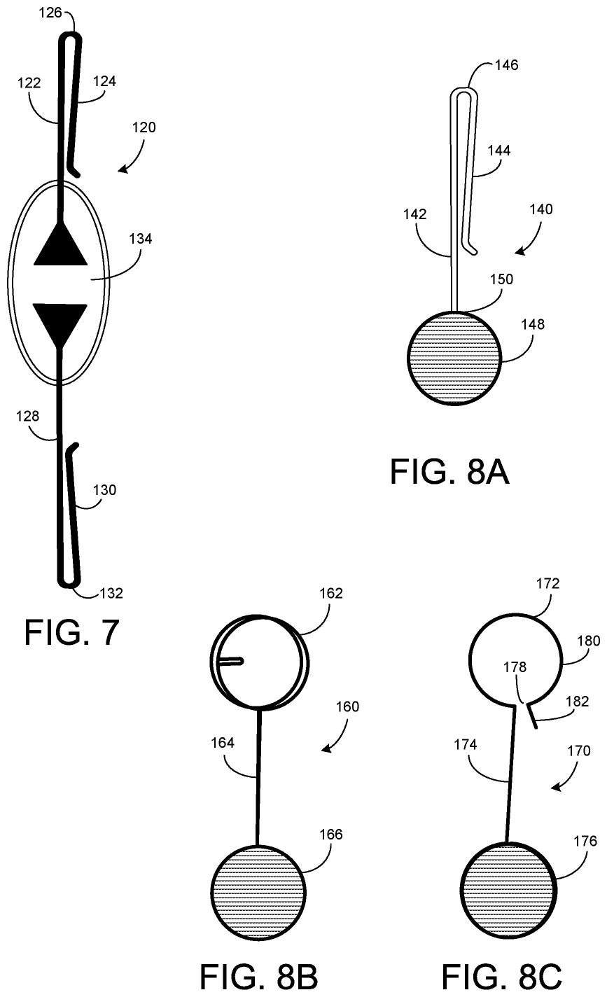

FIG. 7 shows an alternative embodiment 120 of the fishing hook of the present invention. Initially, fishing hook 120 has shank 122 with hairpin loop portion 124 extending downwardly from an upper end 126 of the shank 122. Similarly, there is another shank 128 that has another hairpin loop portion 130 extending upwardly from an end 132 of shank 128. A lure 134 is positioned between the hairpin loop portions 128 and 130. Lure 134 can be a spinnerbait, a scoop, a reflective surface, a spoon or a plug. The hairpin loop portion 124 will have a configuration similar to that described herein previously. The shanks 122 and 128 can be continuous of each other (with the lure 134) affixed thereto, or the shanks 122 and 128 can be separate with the lure 134 flexibly, hingedly, or fixedly joining the shanks 122 and 128 together. The another hairpin loop portion 130 is suitable for receiving bait thereon, a weight thereon, or other fishing attachments. Each of the hairpin loop portions 128 and 130 are on the same side of the respective shanks 122 and 128 so as to reduce visibility by the fish. There are no outwardly extending surfaces (other than the lure 134) that could warn the fish of the fishing hook 120.

FIG. 8A shows a weight 140 that can be used with the present invention. Weight 140 has a shank 142 with a hairpin loop portion 144 extending downwardly from an upper end 146 of the shank 142. Circular weight 148 is affixed to the bottom end 150 of the shank 142. As such, weight 140 can be joined with the another hairpin loop portion 130 of the fishing hook 120 shown in FIG. 7 or can be joined to the lobster clasp or ring clip of the previous embodiments of the present invention.

FIG. 8B shows an alternative embodiment 160 of the weight of FIG. 8A. In FIG. 8B, the weight 160 has a lobster clasp 162 at an upper end of the shank 164. The circular weight 166 is at the opposite end of the shank 164 from the lobster clasp 162. Lobster clasp 162 can be joined to the ring clip, to the lobster clasp, or to the another hairpin loop portion of the previous embodiments of the present invention.

FIG. 8C show still another alternative embodiment 170 of the weight shown in FIG. 8A. FIG. 8C shows a ring clip 172 at an upper end of the shank 174. A circular weight 176 is at the opposite end of the shank 174 from the ring clip 172. Ring clip 172 has a split 178 formed in the circumference of the ring 180. A guide member 182 extends downwardly and outwardly from one side of the split 178. Guide member 182 will facilitate the ability to thread the ring clip, the lobster clasp, or the another hairpin loop portion of the previous embodiments of the present invention.

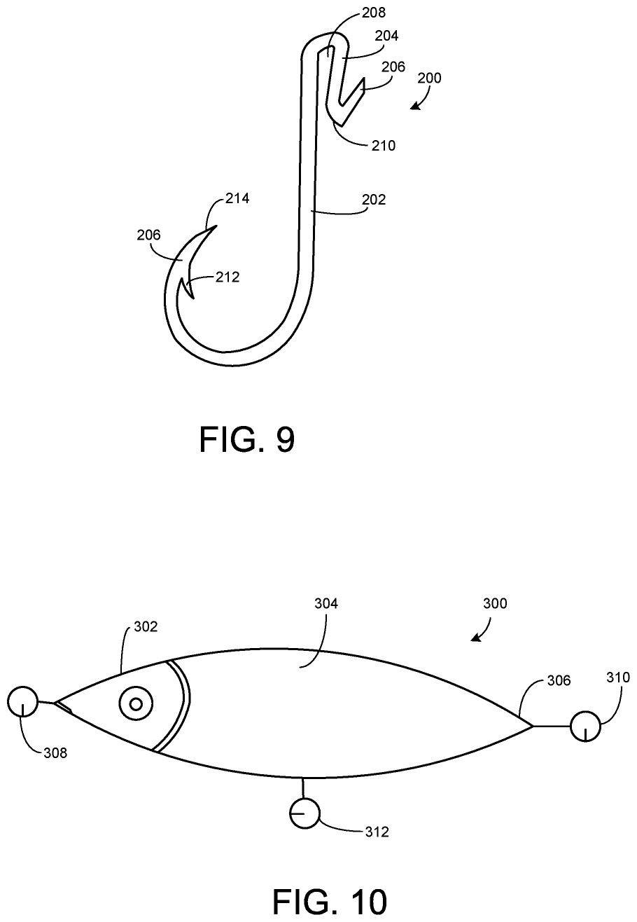

FIG. 9 shows still a further embodiment of the fishing hook 200 of the present invention. The fishing hook 200 is similar to that of FIG. 4 but shows a single hook. In particular, fishing hook 200 includes a shank 202 with a hairpin loop portion 204 at one end thereof and a single fishing hook 206 at an opposite end thereof. The hairpin loop portion 204 extends downwardly from the end of the shank 202. The hairpin loop portion 204 is flattened and has an end 206 that extends away from the shank 202. The shank 202 and the hairpin loop portion 204 define a line-receiving slot 208 therebetween. The end 206 of the hairpin loop portion 204 extends in an upward direction away from the shank 202. There is a tapered area 210 in the hairpin loop portion 204 that acts as a funnel toward the line-receiving slot 208. The end 206 facilitates the application of bait onto the fishing hook 200. The hook 206 a is considered to be the “fastener” of the present invention. Hook 206 includes a barb 212 and a point 214 suitable for capturing a fish.

FIG. 10 shows a lure 300 that can be used with the fishing hook of the present invention. The lure 300, shown in FIG. 10, is in the nature of a minnow-type lure. This type of lure has a head portion 302, a body portion 304 and a tail portion 306. Importantly, in this embodiment, there are clasps 308, 310 and 312 that extend outwardly of the lure 300. In particular, clasp 308 extends outwardly of the forward portion of the head portion 302. Clasp 310 extends outwardly from the tail portion 306. Clasp 312 extends outwardly of the body portion 304. These clasps can easily be secured to the clasps or receptacles of any of the previous embodiments of the present invention. The orientation of the various clasps 308, 310 and 312 allows the fisherman to selectively choose one of the clasps so as to properly orient the lure 300 in relation to the fishing line and the hook. The lure 300 is in the nature of a minnow-type lure. However, it will be appreciated that lure 300 can also be in the nature of a spinnerbait, a scoop, reflective surface, a spoon or a plug.

The foregoing disclosure and description of the invention is illustrative and explanatory thereof. Various changes in the details of the illustrated construction can be made within the scope of the appended claims without departing from the true spirit of the invention. The present invention should only be limited by the following claims and their legal equivalents.

We claim:

1. A fishing hook comprising:
a shank;
a hairpin loop portion formed at an end of said shank, said hairpin loop portion extending down from the end of said shank, said hairpin loop portion being flattened and having a width less than a diameter of said shank, said hairpin loop portion having an end extending away from said shank, said shank and said hairpin loop portion defining a line-receiving slot therebetween, the end of said hairpin loop portion defining a funnel area toward the line-receiving slot; and
a fastener at an opposite end of said shank, said fastener selected from the group consisting of a hook, a ring clip, a lobster clasp, another hairpin loop portion and a weight.

2. The fishing hook claim 1, said hairpin loop portion continuously narrowing from the opposite end of said shank toward the end of said hairpin loop portion.

3. The fishing hook of claim 1, said hairpin loop portion continuously narrowing in width or diameter from the opposite end of said shank.

4. The fishing hook of claim 1, said hairpin loop portion having a longitudinal axis coplanar with a longitudinal axis of said shank.

5. The fishing hook of claim 1, the end of said hairpin loop portion extending downwardly at an obtuse angle from a remainder of said hairpin loop portion.

6. The fishing hook of claim 1, said fastener being hook, the hook being a treble hook.

7. The fishing hook of claim 6, the treble hook having barbs, at least one of the barbs extending outwardly of said shank on a same side of said shank as said hairpin loop portion.

8. The fishing hook of claim 1, said fastener being the ring clip, the ring clip comprising a ring formed at the opposite end of said shank, the ring having a split in a circumference thereof, the split opening to an interior of the ring.

9. The fishing hook of claim 8, the ring having a guide member extending outwardly thereof from one side of the split, the guide member angling upwardly and outwardly away from said shank, the guide member adapted to funnel toward the interior of the ring.

10. The fishing hook of claim 1, said fastener being the lobster clasp, the lobster clasp defining a ring at the opposite end of said shank, the lobster clasp having an arm extending into an interior of the ring, the arm adapted to open and close the ring.

11. The fishing of claim 1, said fastener being the ring clip, the ring clip having an elongated shape, the ring clip having a split adjacent said shank, the ring clip having a guide member extending outwardly from one side of the split, the guide member angling upwardly and away from said shank.

12. The fishing hook of claim 1, said fastener being the lobster clasp, the lobster clasp being of an elongated oval shape, the lobster clasp having an arm extending into an interior of the elongated oval shape, the arm adapted to open and close the lobster clasp.

13. The fishing hook of claim 1, said fastener being the another hairpin loop portion, the another hairpin loop portion extending upwardly from the opposite end of said shank.

14. The fishing hook of claim 13, the another hairpin loop portion being flattened and having a width less than a diameter of said shank, the another hairpin loop portion having an end extending away from said shank, said shank and the another hairpin loop portion defining a line-receiving slot therebetween, the end of the another hairpin loop portion defining a funnel area toward the line-receiving slot.

15. The fishing hook of claim 13, further comprising:
a lure affixed to said shank in a position between the hairpin loop portions.

16. The fishing hook of claim 15, said lure being selected from the group consisting of a spinnerbait, a scoop, a reflective surface, a spoon and a plug.

17. The fishing hook of claim 1, said fastener being the weight, the weight having a circular configuration.

18. The fishing hook of claim 17, the weight having another shank extending upwardly therefrom, the weight and the another hairpin loop portion extending downwardly from an opposite end of the another shank opposite the weight, the another hairpin loop portion adapted to engage with said fastener.

19. The fishing hook of claim 17, the weight having another shank extending upwardly therefrom, the weight having another lobster clasp affixed to an end of the another shank opposite the weight, the another lobster clasp adapted to engage with said fastener.

20. The fishing hook of claim 17, the weight having another shank extending upwardly therefrom, the weight having another ring clip affixed to an end of the another shank opposite the weight, the another ring clip adapted to engage with said fastener.
